(19) United States
(12) Patent Application Publication
(10) Pub. No.: US 2023/0342770 A1
(43) Pub. Date: Oct. 26, 2023

(54) PRODUCT PAYMENT METHOD AND DEVICE USING AI SPEAKER

(71) Applicant: SHINHAN CARD CO., LTD., Seoul (KR)

(72) Inventors: Tae Hyun RYOO, Gyeonggi-do (KR); Sang Yoon RHA, Seoul (KR); Won Geun LEE, Gyeonggi-do (KR); Soo Yong YOON, Gyeonggi-do (KR)

(21) Appl. No.: 18/002,198

(22) PCT Filed: Sep. 21, 2020
(86) PCT No.: PCT/KR2020/012686

§ 371 Date: Dec. 16, 2022

(30) Foreign Application Priority Data
Jun. 17, 2020 (KR) 10-2020-0073371
Jul. 24, 2020 (KR) 10-2020-0092267

(51) Int. Cl. G06Q 20/40; G06Q 20/38; G06Q 20/34; G06F 3/16; G10L 15/22

(52) U.S. Cl. CPC G06Q 20/40; G06Q 20/3821; G06Q 20/34; G06Q 20/386; G06F 3/167; G10L 15/22

(57) ABSTRACT

In order to pay for a product, when a user places an order for a target product, a user terminal: receives, from a set-top box having obtained order information of the target product, a message for calling a target application installed in the user terminal; executes the target application on the basis of the calling; receives order details related to the order from a card company server; receives target card information for a payment from the user; and transmits the target card information to the card company server, and when the target card information is approved by the card company server, the payment for the target product is made.

### TECHNICAL FIELD

The following description relates to a product payment method, and more particularly, to a method of online payment.

### BACKGROUND ART

As a product payment method through home shopping, a credit card, a debit card, or a deposit to a bank account are commonly used. In addition, it is recommended to use a credit card to increase the transparency of taxation in commercial transactions and other different payment methods have been developed. Particularly, with the growth of e-commerce on the Internet, the payment service market has rapidly expanded and currently, a payment method on the Internet is mostly performed by a credit card and bank transfer without a bankbook, however, recently, a new payment method, such as through a user terminal like a mobile phone or an automatic response service (ARS), has emerged and the frequency of use has rapidly increased.

### DISCLOSURE OF THE INVENTION

### Technical Goals

An example embodiment may provide a method and apparatus for performing a payment for a product through an application installed on a user terminal.

Another example embodiment may provide a method and apparatus for pre-registering a user terminal to perform a payment on a card company server by using an artificial intelligence (AI) speaker.

### Technical Solutions

According to an aspect, there is provided a payment performing method performed by a user terminal, the payment performing method including, when a user places an order for a target product, receiving a message to call a target application installed on a user terminal from a set-top box that obtained order information for the target product, executing the target application based on the call, receiving an order history for the order from a card company server, receiving target card information for payment from the user, wherein the target card information includes a target card and a password preset for the target card, and transmitting the target card information to the card company server, wherein, when the target card information is approved by the card company server, a payment for the target product is performed.

The order information may be generated by an artificial intelligence (AT) speaker.

The AI speaker may be configured to receive a user's voice indicating an order for the product from the user and generate the order information by analyzing the user's voice.

The order information may be generated by an AI speaker receiving a user's voice indicating the order of the target product from the user, by the set-top box receiving the order information from the AI speaker, the order information and an account of the set-top box may be transmitted to an affiliate server, by the affiliate server, transaction information may be generated based on the order information and the account of the set-top box, by a payment gate server receiving the transaction information from the affiliate server, an authentication message for the transaction information may be generated based on a transaction number for the set-top box and a token for the user, which are pre-stored, and by the card company server receiving authentication information including the authentication message from the affiliate server, the order history may be generated when the token is authenticated based on the authentication information.

Based on a target sound wave generated by using a one-time card number (OTC) received by the user terminal from the card company server, the token may be generated by the card company server when the OTC is authenticated by the card company server, and the token may be transmitted to the payment gate server.

When the target card information is authenticated by the card company server, voice indicating that the payment for the target product is completed may be output by an AI speaker connected to the set-top box.

According to another aspect, there is provided a user terminal for performing a payment performing method for a target product, the user terminal including a processor configured to execute a program for performing a payment for a target product, and a memory configured to store the program, wherein the program may include when a user places an order for a target product, receiving a message to call a target application installed on a user terminal from a set-top box that obtained order information for the target product, executing the target application based on the call, receiving an order history for the order from a card company server, receiving target card information for payment from the user, wherein the target card information includes a target card and a password preset for the target card, and transmitting the target card information to the card company server, wherein, when the target card information is approved by the card company server, a payment for the target product is performed.

According to another aspect, there is provided an application stored in a computer-readable storage medium allowing a user terminal to, when a user places an order for a target product, receive a message to call a target application installed on a user terminal from a set-top box that obtained order information for the target product, execute the target application based on the call, receive an order history for the order from a card company server, receive target card information for payment from the user, wherein the target card information includes a target card and a password preset for the target card, and transmit the target card information to the card company server, wherein, when the target card information is approved by the card company server, the payment for the target product is performed.

According to another aspect, there is provided a method performed by a user terminal to pre-register a user terminal in a card company server for payment, the method including executing a target application configured to perform a payment, receiving target card information from a user, wherein the target card information includes a target card and a password preset for the target card, and requesting to transmit an OTC to a card company server based on the target card information, receiving the OTC from the card company server, generating a target sound wave based on the OTC, and transmitting the target sound wave to an AI speaker connected to a set-top box by outputting the target sound wave, wherein the set-top box is connected to a payment gate server connected to the card company server, the target sound wave is converted into a target OTC by being decoded by the AI speaker, the target OTC is transmitted to the card company server through the set-top box and the payment gate server, the target OTC is authenticated by the card company server, and when the target OTC is authenticated by the card company server, the user terminal is registered by generating an account of the user terminal by the card company server.

The AI speaker may receive a user's voice indicating a registration request for the user terminal from the user, by analyzing the user's voice, the AI speaker may generate a request message to register the user terminal and transmit the request message to the set-top box, when the set-top box receives the request message, a transaction number may be requested by transmitting a unique number of the set-top box to the payment gate server, the payment gate server may generate an account of the set-top box and the transaction number based on the unique number of the set-top box and transmits the transaction number to the set-top box, and when the set-top box receives the transaction number, the set-top box may control the AI speaker to receive the target sound wave through the AI speaker.

When the user terminal is registered in the card company server, an account of the user terminal may be transmitted to the set-top box, and voice indicating that registration of the user terminal is completed may be output by the AI speaker.

When the target OTC is authenticated by the card company server, a token may be generated by the card company server, and the token may be used later for payment for a product.

According to another aspect, there is provided a user terminal performing a method of registering a user terminal for payment in a card company server, the user terminal including a processor configured to execute a program to register a user terminal in a card company server, and a memory configured to store the program, wherein the program includes executing a target application configured to perform a payment, receiving target card information from a user, wherein the target card information includes a target card and a password preset for the target card, and requesting to transmit an OTC to the card company server based on the target card information, receiving the OTC from the card company server, generating a target sound wave based on the OTC, and transmitting the target sound wave to an AI speaker connected to a set-top box by outputting the target sound wave, wherein the set-top box is connected to a payment gate server connected to the card company server, the target sound wave is converted into a target OTC by being decoded by the AI speaker, the target OTC is transmitted to the card company server through the set-top box and the payment gate server, the target OTC is authenticated by the card company server, and when the target OTC is authenticated by the card company server, the user terminal is registered by generating an account of the user terminal by the card company server.

According to another aspect, there is provided an application stored in a computer-readable storage medium allowing a user terminal to execute a target application configured to perform a payment, receive target card information from a user, wherein the target card information includes a target card and a password preset for the target card, and request to transmit an OTC to a card company server based on the target card information, receive the OTC from the card company server, generate a target sound wave based on the OTC, and transmit the target sound wave to an AI speaker connected to a set-top box by outputting the target sound wave, wherein the set-top box is connected to a payment gate server connected to the card company server, the target sound wave is converted into a target OTC by being decoded by the AI speaker, the target OTC is transmitted to the card company server through the set-top box and the payment gate server, the target OTC is authenticated by the card company server, and when the target OTC is authenticated by the card company server, the user terminal is registered by generating an account of the user terminal by the card company server.

### Effects

A method and apparatus for performing a payment for a product through an application installed on a user terminal may be provided.

Another embodiment may provide a method and apparatus for pre-registering a user terminal for performing a payment on a card company server using an AI speaker.

### BRIEF DESCRIPTION OF DRAWINGS

FIG. 1 is a diagram illustrating a configuration of a product payment system, according to an example.

FIG. 2 is a flowchart illustrating a product payment method and a method of pre-registering a user terminal using a sound wave, according to an example.

FIG. 3 is a signal flowchart of a method of transmitting a one-time card number (OTC) to a user terminal to pre-register the user terminal in a card company server, according to an example.

FIG. 4 is a signal flowchart of a method of pre-registering a user terminal in a card company server based on an OTC transmitted to the user terminal, according to an example.

FIG. 5 is a flowchart of a method of performing a payment for a product purchased by a user, according to an example.

FIG. 6 is a signal flowchart of a method of registering an account of an artificial intelligence (AI) speaker in a card company server, according to an example.

FIG. 7 is a diagram illustrating a configuration of a user terminal, according to an example.

### BEST MODE FOR CARRYING OUT THE INVENTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Also, in the description of the components, teens such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the example embodiments described above and an element having a common function. Unless otherwise mentioned, the descriptions on the example embodiments may be applicable to the following example embodiments and thus, duplicated descriptions will be omitted for conciseness.

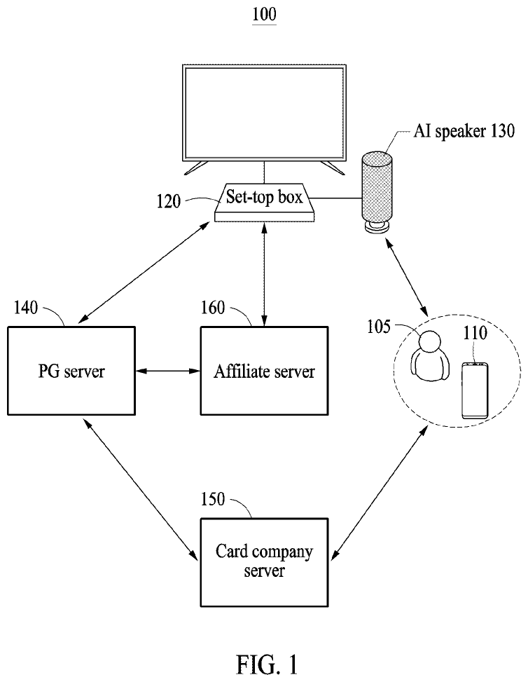

FIG. 1 is a diagram illustrating a configuration of a product payment system, according to an example.

According to an aspect, a product payment system 100 for recognizing an order of a product through voice of a user 105 using an artificial intelligence (AI) speaker 130 and performing a payment through an application of a user terminal 110 may be considered.

The product payment system 100 may include the user terminal 110, a set-top box 120, the AI speaker 130 connected to the set-top box 120, a payment gate (PG) server 140, a card company server 150, and an affiliate server 160.

A card company may issue a card used for payment for purchase of a product to the user 105 and information thereof may be managed by the card company server 150. For example, the card may include a credit card and a debit card, and is not limited to the examples described above. The card company server 150 may further include a mobile server configured to directly communicate with a mobile terminal.

An application for managing the card issued to the user 105 and performing a payment may be installed on the user terminal 110. The application may be an application distributed by the card company server 150.

The user 105 may order a product through voice, the AI speaker 130 may identify the order for the product by analyzing the user's voice, and the set-top box 120 connected to the AI speaker 130 may transmit order information to the affiliate server 160 that sells products. For example, the user 105 may watch a home shopping program output through an internet protocol television (IPTV) connected to the set-top box 120 and order a related product.

The set-top box 120 may be connected to the PG server 140 and the affiliate server 160 through a server operated by a business operator of the set-top box 120. According to an aspect, a set-top box server connected to the set-top box 120 may exist and the set-top box 120 may be controlled by the set-top box server (for example, a communication company server). That is, the PG server 140 and the affiliate server 160 may be connected to the set-top box 120 through the set-top box server. Hereinafter, for brevity and ease of description, a detailed description of the set-top box is not provided, however data transmitted by the set-top box 120 (or the AI speaker 130) or data transmitted to the set-top box 120 may be understood as data transmitted by the set-top box server or data transmitted to the set-top box server.

The affiliate server 160 may generate transaction information based on the order information received from the set-top box 120 and may transmit the transaction information to the PG server 140. The PG server 140 and the card company server 150 may proceed with the payment for the product based on the transaction information. The user 105 may perform the payment for the product ordered through the application installed on the user terminal 110.

To perform the payment method described above, the user who ordered the product through voice may need to be the same as the user of the user terminal 110. Otherwise, a problem, such as a fraudulent payment, may occur. To prevent such a problem, a method of pre-registering the user terminal 110 or the application installed on the user terminal 110 in the card company server 150 may be considered. The user 105 may register the user terminal 110 or the application installed on the user terminal 110 in the card company server 150 through pre-authentication. Through registration described above, pairing between the AI speaker 130 (or the set-top box 120) and the user terminal 110 (or the application installed on the user terminal 110) may be performed.

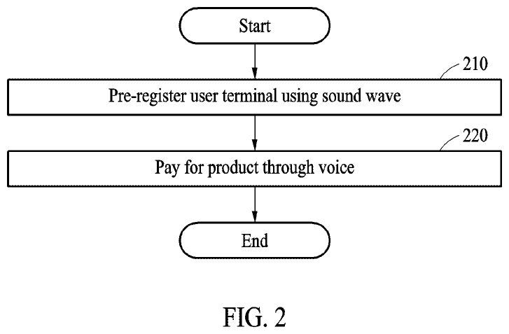

Hereinafter, a detailed description of a method of ordering and paying for a product through voice is provided with reference to FIGS. 2 to 7.

FIG. 2 is a flowchart illustrating a product payment method and a method of pre-registering a user terminal using a sound wave, according to an example.

To perform the method of ordering and paying for a product through voice described with reference to FIG. 1, operations 210 and 220 described below may be performed.

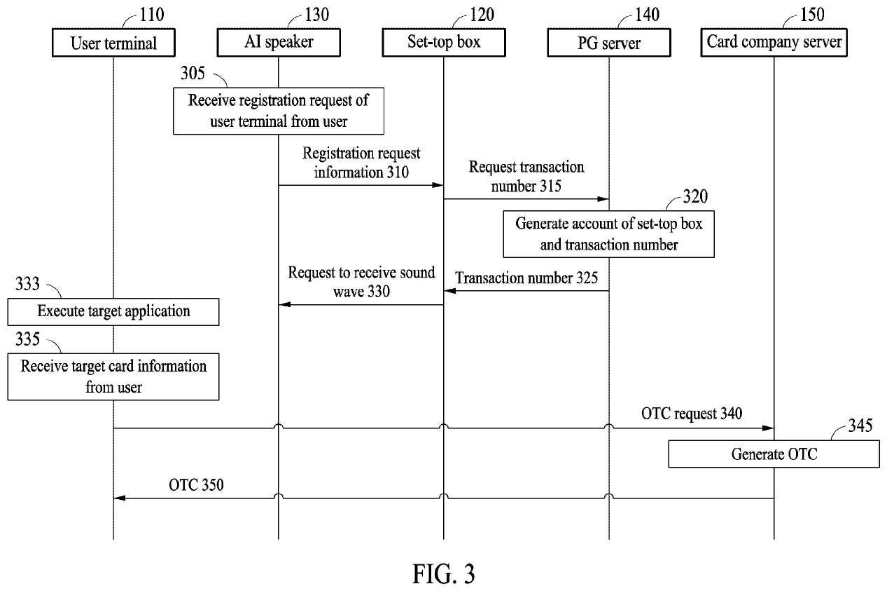

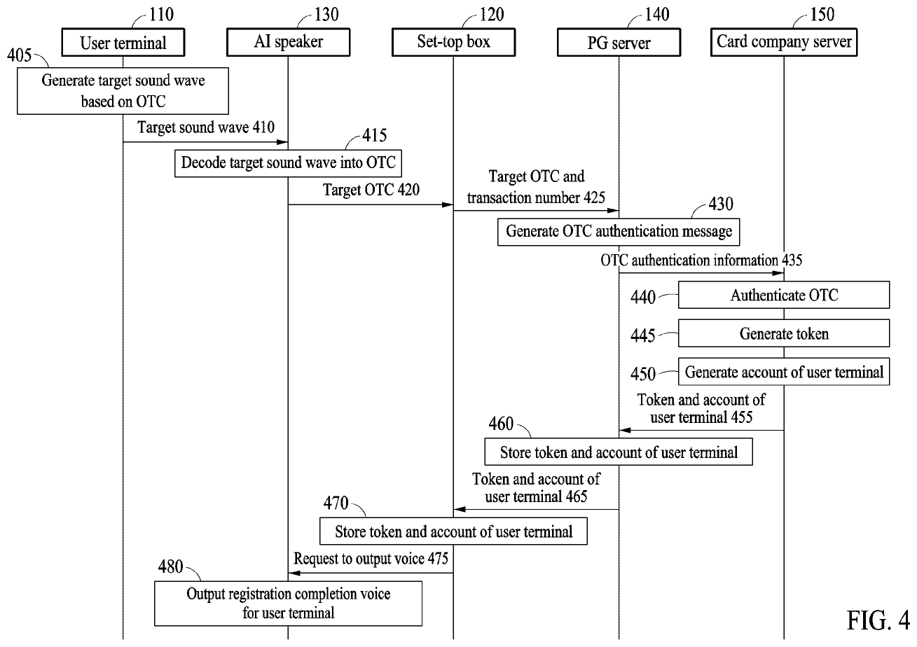

In operation 210, pre-registration of a user terminal may be performed by using a sound wave. A detailed description of operation 210 is provided below with reference to FIGS. 3 and 4.

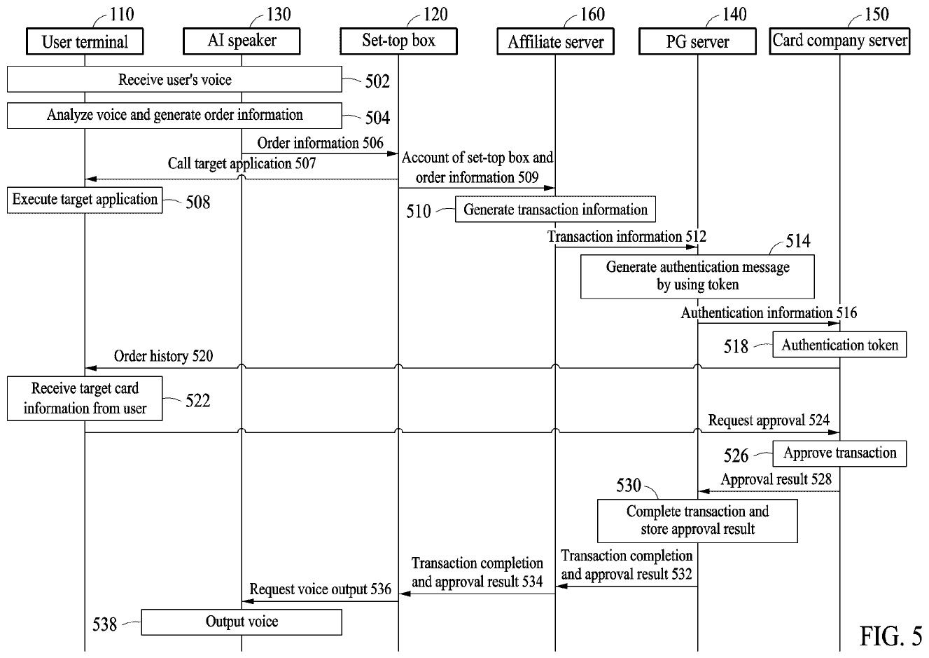

In operation 220, a payment for a product may be performed through a user's voice. A detailed description of operation 220 is provided below with reference to FIG. 5.

FIG. 3 is a signal flowchart of a method of transmitting a one-time card number (OTC) to a user terminal to pre-register the user terminal in a card company server, according to an example.

Operation 210 described above with reference to FIG. 2 may include operations 305 to 350 described below.

In operation 305, the AI speaker 130 may receive the voice of a user requesting registration of the user terminal 110 (or an application installed on the user terminal 110) from the user. For example, the user may utter “Register a target application” as the user's voice. When the AI speaker 130 receives the user's voice, the AI speaker 130 may generate registration request information.

The AI speaker 130 may be controlled by the set-top box 120 through an AI speaker application installed on the set-top box 120.

In operation 310, the AI speaker 130 may transmit the registration request information to the set-top box 120.

In operation 315, when the set-top box 120 receives the registration request information, the set-top box 120 may transmit a request for a transaction number to the PG server 140 connected to the set-top box 120. For example, the PG server 140 may be the PG server 140 associated with a card company that contracted with a business operator of the set-top box 120 in advance.

The transaction number may be transaction identification (TID). The request for the transaction number may include a unique number of the set-top box 120.

In operation 320, when the PG server 140 receives the request for the transaction number, the PG server 140 generates an account of the set-top box 120 by storing the unique number of the set-top box 120 and may generate the transaction number for the set-top box 120. When an order for a product is placed in the future, the transaction number for the set-top box 120 may be used to determine whether the order is properly processed from the set-top box 120.

In operation 325, the PG server 140 may transmit the transaction number for the set-top box 120 to the set-top box 120. Additionally, the PG server 140 may transmit the account of the set-top box to the set-top box 120.

In operation 330, when the set-top box 120 receives the transaction number, the set-top box 120 may transmit a request to receive a sound wave to the AI speaker 130. For example, the set-top box 120 (for example, a telecommunication company server) may control the AI speaker 130 to receive a sound wave. The AI speaker 130 may be controlled to receive the sound wave propagated from the user terminal 110.

Operations 333, 335, 340, and 345 may be performed independently or in parallel with operations 305, 310, 315, 320, 325, and 330.

In operation 333, the user terminal 110 may execute a target application in response to a command of a user. For example, the target application may be an application for managing a card to perform a payment. The user terminal 110 may be connected to the card company server 150 through the target application. The user may select a function to register the user terminal 110 or the target application in the card company server 150 among various functions provided by the target application.

In operation 335, the user terminal 110 may receive target card information from the user. For example, the target card information may include information of a target card to be used for payment among a plurality of cards and a password of the target card. The password of the target card may be an app card password.

In operation 340, the user terminal 110 may transmit a request for an OTC to the card company server 150. The request for an OTC may include the target card information. Additionally, the request for an OTC may include an identifier (ID) of the target application installed on the user terminal 110.

In operation 345, when the card company server 150 receives the request for an OTC, the card company server 150 may authenticate the user based on the target card information and when the user is authenticated, may generate the OTC. For example, the OTC may be generated by an arbitrary method.

FIG. 4 is a signal flowchart of a method of pre-registering a user terminal in a card company server based on an OTC transmitted to the user terminal, according to an example.

Operation 210 described with reference to FIG. 2 may include operations 405 to 480 described below. Operation 405 described below may be performed after operation 350 described with reference to FIG. 3 is performed.

In operation 405, the user terminal 110 may generate a target sound wave based on an OTC received from the card company server 140. The target sound wave may be a sound wave obtained by converting alphanumeric characters representing the OTC into the sound wave. A method of converting an OTC into a sound wave may be set in advance. For example, a frequency corresponding to each slot value of the OTC may be allocated.

In operation 410, the user terminal 110 may propagate the target sound wave to the surroundings through a speaker. The AI speaker 130 may receive the propagated target sound wave.

In operation 415, the AI speaker 130 may generate a target OTC by decoding the target sound wave into the OTC. The method of decoding a target sound wave into an OTC may be preset to correspond to the method of converting an OTC into a sound wave of operation 405.

In operation 420, the AI speaker 130 may transmit the target OTC to the set-top box 120.

In operation 425, the set-top box 120 may transmit the target OTC and a transaction number of the set-top box 120 to the PG server 140.

In operation 430, the PG server 140 may generate an OTC authentication message based on the target OTC and the transaction number. The OTC authentication message may include OTC authentication information required to authenticate the OTC.

In operation 435, the PG server 140 may transmit the OTC authentication information of the generated OTC authentication message to the card company server 150.

In operation 440, the card company server 150 may authenticate the OTC based on the OTC authentication information. The card company server 150 may determine whether the target OTC of the OTC authentication information coincides with the OTC generated for the target card.

In operation 445, when the OTC is authenticated, the card company server 150 may generate a token. For example, the token may be generated based on an identification number of the target card, an ID of the target application, and the unique number of the set-top box. When a user proceeds with a transaction using the target card, the token may be used to verify the steps of the transaction.

According to an aspect, the token may be in the form of 16 bytes and may be composed of 7 bytes representing the identification number of the target card, 8 bytes representing random data, and 1 byte representing check data. For example, the random data may be generated based on the ID of the target application, the unique number of the set-top box, and the like.

Through the token, a service subscribed by a user may be managed. Service management may include subscription, cancellation, and management of expiration date, and is not limited to the examples described above. For example, the token may be included in data generated for a transaction. The data generated for a transaction may include a token, an expiration date, service code, and transaction classification.

In operation 450, the card company server 150 may generate an account of the user terminal. For example, the account of the user terminal may be an account for identifying the target application installed on the user terminal 110. The account for identifying the target application may be generated based on the ID of the target application received in operation 340.

In operation 455, the card company server 150 may transmit the token and the account of the user terminal to the PG server 140.

In operation 460, the PG server 140 may store the received token and the received account of the user terminal. For example, the PG server 140 may associate the account of the user terminal with an account of the set-top box based on the token.

In operation 465, the PG server 140 may transmit the token and the account of the user terminal to the set-top box 120.

In operation 470, the set-top box 120 may store the received token and the received account of the user terminal. For example, the set-top box 120 may store the token and the account of the user terminal in the AI speaker application.

In operation 475, the set-top box 120 may transmit a request to output voice to the AI speaker 130 to output voice indicating that registration is completed.

In operation 480, the AI speaker 130 may output voice indicating that registration of the user terminal is completed. When the voice described above is output, the user 105 may recognize that the selected target card is registered in the card company server 150. The target card registered in the card company server 150 through the above procedure may be used to perform a payment through voice.

FIG. 5 is a flowchart of a method of performing payment for a product purchased by a user, according to an example.

Operation 220 described with reference to FIG. 2 may include operations 502 to 538 described below. According to an aspect, operation 502 may be performed after operation 480 described with reference to FIG. 4 is performed.

In operation 502, the user terminal 110 or the AI speaker 130 may receive a user's voice indicating an order of a target product from a user. The user may obtain information of the target product through home shopping output through the set-top box 120 or an advertisement output through the user terminal 110 and may proceed with an order for the target product through voice. According to an aspect, the home shopping output through the set-top box 120 may be provided to the user in a video on demand (VOD) format or a data broadcast format, and is not limited to the examples described above. For example, the home shopping may be provided to the user in a live broadcast format rather than the data broadcast format.

According to another aspect, the advertisement output through the user terminal 110 may be provided through an application installed on the user terminal 110. For example, the advertisement may be provided through a target application, however the advertisement may be provided through another application installed on the user terminal 110 related to sales of the product, and is not limited to the examples described above.

The user terminal 110 may receive the user's voice through an AI speaker application installed on the user terminal 110. A second AI speaker application installed on the user terminal 110 and a first AI speaker application installed on the set-top box 120 may control the AI speaker 130 and may interoperate with each other through a set-top box server connected to the set-top box 120.

In operation 504, the user terminal 110 or the AI speaker 130 may generate order information by analyzing the user's voice. The order information may include an option of the target product. Additionally, the AI speaker 130 may identify a target user among a plurality of users based on the user's voice and may include information of the identified target user in the order information.

In operation 506, the user terminal 110 or the AI speaker 130 may transmit the order information to the set-top box 120. Specifically, the order information may be transmitted to the set-top box server connected to the set-top box 120.

In operation 507, when the set-top box 120 receives the order information, the set-top box 120 may call a target application installed on the user terminal 110. For example, a target user terminal (or the target application) may be identified from a plurality of user terminals connected to the set-top box 120, based on the target user's information included in the order information. For example, user terminals of a father, a mother, and a child may be connected to the set-top box 120 in advance and when an order for a product is placed by the mother, a target application installed on the mother's user terminal may be called. Such a call for the target application may be application push.

In operation 508, the user terminal 110 may execute the target application. For example, when a call for the target application is received, the target application may be automatically executed. In another example, the target application may be executed in response to an execution command of the user who identified the call for the target application.

In operation 509, the set-top box 120 may transmit an account of the set-top box and the order information to the affiliate server 160. When a plurality of affiliate servers is connected to the set-top box 120, the set-top box 120 may identify a target affiliate server 160 based on at least one of information of home shopping currently viewed by the user or the order information.

In operation 510, the affiliate server 160 may generate transaction information based on at least one of the account of the set-top box, the order information, an affiliate number, a transaction amount, a business number, and a name of a business operator.

In operation 512, the affiliate server 160 may transmit the generated transaction information to the PG server 140.

In operation 514, the PG server 140 may identify a token to be used based on the transaction information and generate an authentication message using the token. The authentication message may be generated based on the token and the transaction information. The authentication message may include authentication information for authenticating the token.

In operation 516, the PG server 140 may transmit the authentication information to the card company server 150.

In operation 518, the card company server 150 may authenticate the token of the authentication information. For example, it may be determined whether a stored token coincides with the token of the authentication information.

When the token of the authentication information is authenticated, the card company server 150 may generate an order history based on the transaction information.

In operation 520, the card company server 150 may transmit the order history to the user terminal 110. Operation 520 described an example that the card company server 150 transmits the order history to the user terminal 110, however as another example, the card company server 150 may transmit the order history to the set-top box 120 (for example, the AI speaker application) and the set-top box 120 may transmit the order history while calling the target application of the user terminal 110.

In operation 522, the user terminal 110 may receive target card information to pay for the ordered target product from the user. The target card information may include information of the target card and a password of the target card. For example, the type of the password may be text, a pattern, biometric information, voice, and the like, and the type and form of the password are not limited thereto. The user terminal 110 may generate an approval request for the order history based on the target card information.

For example, the user terminal 110 may receive the user's voice as the password from the user through the second AI speaker application where the users' voice indicates the approval request and may authenticate the received user's voice. The second AI speaker application may be executed with the target application through an application programming interface (API) of the target application. When the user's voice is authenticated through the second AI speaker application, the target application may determine that a required password for the target card is received.

In operation 524, the user terminal 110 may transmit the generated approval request to the card company server 150.

In operation 526, the card company server 150 may verify the approval request and when the approval request is verified, the card company server 150 may approve the transaction. When the target card information is approved by the card company server 150, a payment for the target product may be performed.

In operation 528, the card company server 150 may transmit an approval result to the PG server 140.

In operation 530, when the PG server 140 receives the approval result, the PG server 140 may complete the transaction and store the approval result.

In operation 532, the PG server 140 may transmit transaction completion and the approval result to the affiliate server 160.

In operation 534, the affiliate server 160 may transmit the transaction completion and the approval result to the set-top box 120 of an affiliate member.

In operation 536, the set-top box 120 may transmit a voice output request to the AI speaker 130 to output voice indicating that the payment for the target product is completed.

In operation 538, the AI speaker 130 may output the voice indicating that the payment for the product is completed. For example, the output voice may be “the requested order and payment are completed”. The user may recognize that the payment is completed by the output voice through the AI speaker 130.

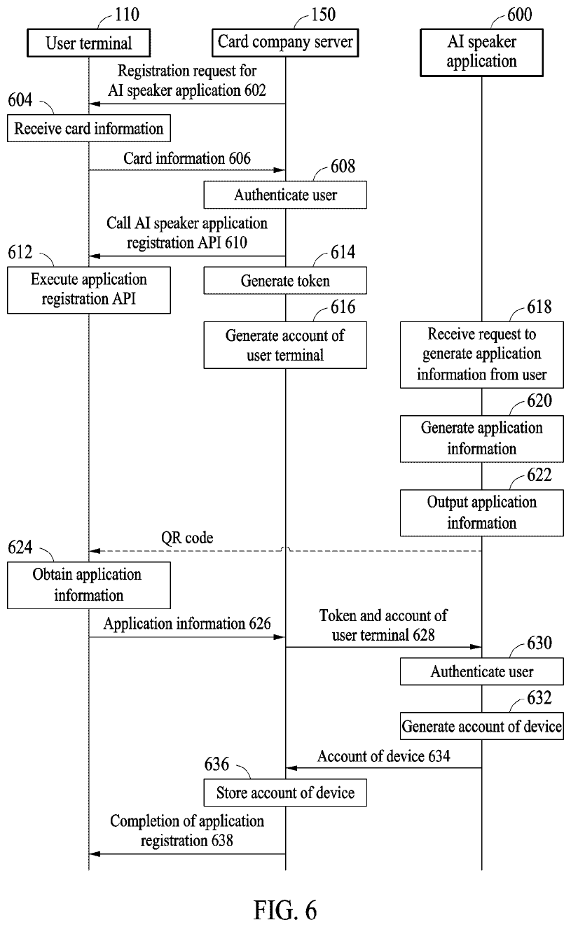

FIG. 6 is a signal flowchart of a method of registering an account of an AI speaker in a server of a card company, according to an example.

According to an aspect, operations 602 to 638 may be performed before operation 210 described with reference to FIGS. 2 to 4 is performed. The following operations 602 to 638 may be performed to register a device on which an AI speaker application 600 is installed in the card company server 150.

In operation 602, the card company server 150 may transmit a registration request for an AI speaker application to the user terminal 110. For example, the card company server 150 may transmit the registration request to a target application installed on the user terminal 110 as a push notification.

In operation 604, the user terminal 110 may receive card information from a user. The received card information may be used for user authentication.

In operation 606, the user terminal 110 may transmit the card information to the card company server 150.

In operation 608, the card company server 150 may perform the user authentication based on the received card information.

In operation 610, when the user authentication is performed, the card company server 150 may call an AI speaker application registration API of the target application installed on the user terminal 110. When the AI speaker application is not installed on the user terminal 110, an operation of installing the AI speaker application on the user terminal 110 may be performed. For example, the card company server 150 may perform installation of the AI speaker application on the user terminal 110 through the target application.

In operation 612, the user terminal 110 may execute an API to register an application.

In operation 614, the card company server 150 may generate a token to perform a payment.

In operation 616, the card company server 150 may generate an account of the user terminal.

In operation 618, the AI speaker application 600 may receive a generation request for application information from the user. For example, the AI speaker application 600 may be an application installed on the set-top box 120 to control the AI speaker 130. In another example, the AI speaker application 600 may be an application installed on the AI speaker 130.

The AI speaker application 600 may receive and analyze a request of the user through the AI speaker 130.

In operation 620, the AI speaker application 600 may generate the application information. For example, the application information may include a uniform resource locator (URL) that may be connected to the AI speaker application 600.

According to an aspect, the application information may be in the form of a barcode. For example, the application information may be generated in the form of a quick response (QR) code.

In operation 622, the AI speaker application 600 may output the application information. For example, the AI speaker application 600 may output the generated QR code through a display. In another example, the application information may be represented as text. The application information may be generated in a type that may represent information, and the example is not limited thereto.

In operation 624, the user terminal 110 may obtain the output application information. For example, the user terminal 110 may obtain the application information by scanning the QR code output on the display by using a camera of the user terminal 110. In another example, the user may input text representing the application information to the user terminal 110.

Although the example of obtaining the application information through operations 618 to 622 is described above, different examples of obtaining the application information may be implemented. For example, after operation 612 is performed, in operation 624, the user terminal 110 may obtain the application information by generating the application information of the AI speaker application installed on the user terminal 110.

In operation 626, the user terminal 110 may transmit the obtained application information to the card company server 150.

In operation 628, the card company server 150 may obtain an address of the AI speaker application 600 based on the application information and transmit the token and the account of the user terminal to the AI speaker application 600.

In operation 630, when the AI speaker application 600 receives the token and the account of the user terminal, the AI speaker application 600 may perform user authentication. For example, the user authentication may be performed through an external authentication institution.

In operation 632, the AI speaker application 600 may generate an account of a device (for example, the set-top box 120 or the AI speaker 130) on which the AI speaker application 600 is installed. For example, the account of the device may be the account of the set-top box described above with reference to operation 509 of FIG. 5. The account of the device may be a unique number of the device.

In operation 634, the AI speaker application 600 may transmit the account of the device to the card company server 150.

In operation 636, the card company server 150 may store the account of the device. By using the account of the device, the card company server 150 may process a command corresponding to voice collected by the AI speaker 130.

In operation 638, the card company server 150 may transmit application registration completion to the user terminal 110.

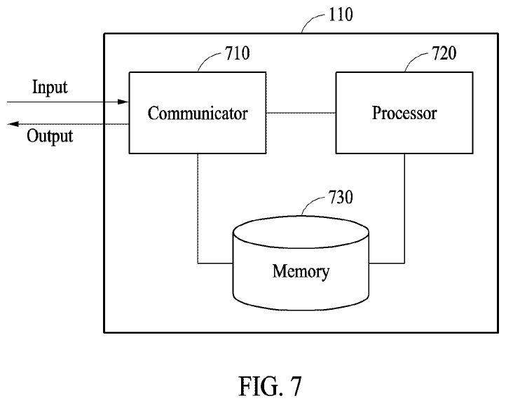

FIG. 7 is a diagram illustrating a configuration of a user terminal, according to an example.

According to an aspect, the user terminal 110 may include a communicator 710, a processor 720, and a memory 730. For example, the user terminal 110 may be a terminal on which an application is installed, such as a smartphone.

The communicator 710 may be connected to the processor 720 and the memory 730 and may transmit and receive data to and from the processor 720 and the memory 730. The communicator 710 may be connected to another external device and may transmit and receive data to and from the external device. Hereinafter, transmitting and receiving “A” may refer to transmitting and receiving “information or data indicating A.”

The communicator 710 may be implemented as a circuit in the user terminal 110. For example, the communicator 710 may include an internal bus and an external bus. In another example, the communicator 710 may be an element configured to connect the user terminal 110 to an external device. The communicator 710 may be an interface. The communicator 710 may receive data from the external device and transmit the data to the processor 720 and the memory 730.

The processor 720 may process the data received by the communicator 710 and data stored in the memory 730. A “processor” may be a hardware-implemented processing device having a physically structured circuit to execute desired operations. For example, the desired operations may include code or instructions in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 720 may execute computer-readable code (e.g., software) stored in a memory (e.g., the memory 730) and instructions triggered by the processor 720.

The memory 730 may store therein the data received by the communicator 710 and the data processed by the processor 720. For example, the memory 730 may store the program (or an application, or software). The stored program or application may be a set of syntaxes that are coded to perform a payment for a product and executable by the processor 720.

According to an aspect, the memory 730 may include, for example, at least one volatile memory, nonvolatile memory, random-access memory (RAM), flash memory, a hard disk drive, and an optical disc drive.

The memory 730 may store an instruction set (e.g., an application) for operating the user terminal 110. The instruction set for operating the user terminal 110 may be executed by the processor 720.

The methods according to the above-described examples may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape, optical media such as CD-ROM discs, DVDs, and/or Blue-ray discs, magneto-optical media such as optical discs, and hardware devices that are specially configured to store and perform program instructions, such as read-only memory (ROM), RAM, flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or pseudo equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A payment performing method performed by a user terminal, the payment performing method comprising:
when a user places an order for a target product, receiving a message to call a target application installed on a user terminal from a set-top box that obtained order information for the target product;
executing the target application based on the call;
receiving an order history for the order from a card company server;
receiving target card information for payment from the user, wherein the target card information comprises a target card and a password preset for the target card; and
transmitting the target card information to the card company server,
wherein, when the target card information is approved by the card company server, a payment for the target product is performed.

2. The payment performing method of claim 1, wherein the order information is generated by an artificial intelligence (AI) speaker.

3. The payment performing of claim 2, wherein the AI speaker is configured to receive a user's voice indicating an order for the product from the user and generate the order information by analyzing the user's voice.

4. The payment performing method of claim 1, wherein the order information is generated by an artificial intelligence (AI) speaker receiving a user's voice indicating the order of the target product from the user,
by the set-top box receiving the order information from the AI speaker, the order information and an account of the set-top box are transmitted to an affiliate server,
by the affiliate server, transaction information is generated based on the order information and the account of the set-top box,
by a payment gate server receiving the transaction information from the affiliate server, an authentication message for the transaction information is generated based on a transaction number for the set-top box and a token for the user, which are pre-stored, and
by the card company server receiving authentication information comprising the authentication message from the affiliate server, the order history is generated when the token is authenticated based on the authentication information.

5. The payment performing method of claim 4, wherein, based on a target sound wave generated by using a one-time card number (OTC) received by the user terminal from the card company server, the token is generated by the card company server when the OTC is authenticated by the card company server, and the token is transmitted to the payment gate server.

6. The payment performing method of claim 1, wherein, when the target card information is authenticated by the card company server, voice indicating that the payment for the target product is completed is output by an artificial intelligence (AI) speaker connected to the set-top box.

7. A non-transitory computer-readable storage medium storing instructions that, when executed by a processor, cause the processor to perform the method of claim 1.

8. A user terminal for performing a payment performing method for a target product, the user terminal comprising:
a processor configured to execute a program for performing a payment for a target product; and
a memory configured to store the program,
wherein the program comprises:
when a user places an order for a target product, receiving a message to call a target application installed on a user terminal from a set-top box that obtained order information for the target product;
executing the target application based on the call;
receiving an order history for the order from a card company server;
receiving target card information for payment from the user, wherein the target card information comprises a target card and a password preset for the target card; and
transmitting the target card information to the card company server,
wherein, when the target card information is approved by the card company server, a payment for the target product is performed.

9. An application stored in a computer-readable storage medium allowing a user terminal to:
when a user places an order for a target product, receive a message to call a target application installed on a user terminal from a set-top box that obtained order information for the target product;
execute the target application based on the call;
receive an order history for the order from a card company server;
receive target card information for payment from the user, wherein the target card information comprises a target card and a password preset for the target card; and
transmit the target card information to the card company server,
wherein, when the target card information is approved by the card company server, the payment for the target product is performed.

10. A method performed by a user terminal to pre-register a user terminal in a card company server for payment, the method comprising:
executing a target application configured to perform a payment;
receiving target card information from a user, wherein the target card information comprises a target card and a password preset for the target card; and
requesting to transmit a one-time card number (OTC) to a card company server based on the target card information;
receiving the OTC from the card company server;
generating a target sound wave based on the OTC; and
transmitting the target sound wave to an artificial intelligence (AI) speaker connected to a set-top box by outputting the target sound wave,
wherein the set-top box is connected to a payment gate server connected to the card company server,
the target sound wave is converted into a target OTC by being decoded by the AI speaker,
the target OTC is transmitted to the card company server through the set-top box and the payment gate server,
the target OTC is authenticated by the card company server, and
when the target OTC is authenticated by the card company server, the user terminal is registered by generating an account of the user terminal by the card company server.

11. The method of claim 10, wherein the AI speaker receives a user's voice indicating a registration request for the user terminal from the user,
by analyzing the user's voice, the AI speaker generates a request message to register the user terminal and transmit the request message to the set-top box,
when the set-top box receives the request message, a transaction number is requested by transmitting a unique number of the set-top box to the payment gate server,
the payment gate server generates an account of the set-top box and the transaction number based on the unique number of the set-top box and transmits the transaction number to the set-top box, and
when the set-top box receives the transaction number, the set-top box controls the AI speaker to receive the target sound wave through the AI speaker.

12. The method of claim 10, wherein, when the user terminal is registered in the card company server, an account of the user terminal is transmitted to the set-top box, and
voice indicating that registration of the user terminal is completed is output by the AI speaker.

13. The method of claim 10, wherein, when the target OTC is authenticated by the card company server, a token is generated by the card company server, and
the token is used later for payment for a product.

14. A non-transitory computer-readable storage medium storing instructions that, when executed by a processor, cause the processor to perform the method of claim 10.

15. A user terminal performing a method of registering a user terminal for payment in a card company server, the user terminal comprising:
a processor configured to execute a program to register a user terminal in a card company server; and
a memory configured to store the program,
wherein the program comprises:
executing a target application configured to perform a payment;
receiving target card information from a user, wherein the target card information comprises a target card and a password preset for the target card; and
requesting to transmit a one-time card number (OTC) to the card company server based on the target card information;
receiving the OTC from the card company server;
generating a target sound wave based on the OTC; and
transmitting the target sound wave to an artificial intelligence (AI) speaker connected to a set-top box by outputting the target sound wave,
wherein the set-top box is connected to a payment gate server connected to the card company server,
the target sound wave is converted into a target OTC by being decoded by the AI speaker,
the target OTC is transmitted to the card company server through the set-top box and the payment gate server,
the target OTC is authenticated by the card company server, and
when the target OTC is authenticated by the card company server, the user terminal is registered by generating an account of the user terminal by the card company server.

16. An application stored in a computer-readable storage medium allowing a user terminal to:
execute a target application configured to perform a payment;
receive target card information from a user, wherein the target card information comprises a target card and a password preset for the target card; and
request to transmit a one-time card number (OTC) to a card company server based on the target card information;
receive the OTC from the card company server;
generate a target sound wave based on the OTC; and
transmit the target sound wave to an artificial intelligence (AI) speaker connected to a set-top box by outputting the target sound wave,
wherein the set-top box is connected to a payment gate server connected to the card company server,
the target sound wave is converted into a target OTC by being decoded by the AI speaker,
the target OTC is transmitted to the card company server through the set-top box and the payment gate server,
the target OTC is authenticated by the card company server, and
when the target OTC is authenticated by the card company server, the user terminal is registered by generating an account of the user terminal by the card company server.
